(19) United States
(12) Patent Application Publication
(10) Pub. No.: US 2026/0149210 A1
(43) Pub. Date: May 28, 2026

(54) CONNECTOR

(71) Applicant: Bellwether Electronic Corp., Taoyuan City (TW)

(72) Inventors: Robert Hla THEIN, Taoyuan City (TW); Chih-Ming TSAI, Taoyuan City (TW); Jimmy Enrique ACERA, Taoyuan City (TW)

(21) Appl. No.: 19/398,052

(22) Filed: Nov. 24, 2025

Related U.S. Application Data
(60) Provisional application No. 63/724,423, filed on Nov. 25, 2024.

(51) Int. Cl. H01R 13/24; H01R 12/70; H01R 12/91; H01R 13/08; H01R 13/11; H01R 13/508

(52) U.S. Cl. CPC H01R 13/2407; H01R 12/707; H01R 12/91; H01R 13/08; H01R 13/111; H01R 13/2492; H01R 13/508

(57) ABSTRACT

A connector includes a connecting member, a connecting base and a disc-shaped spring terminal. The connecting member includes a limiting portion and a plug portion connected with the limiting portion. The plug portion extends along a mating direction. The connecting base has an accommodation space and an opening communicated with the accommodation space. The limiting portion is located in the accommodation space. The plug portion passes through the opening. The disc-shaped spring terminal is located in the accommodation space and sandwiched between the connecting base and the limiting portion along the mating direction.

### RELATED APPLICATIONS

This application claims priority to U.S. Provisional Application Ser. No. 63/724,423, filed Nov. 25, 2024, which is herein incorporated by reference in its entirety.

### BACKGROUND

### Technical Field

The present disclosure relates to connectors, and particularly to conductive connectors.

### Description of Related Art

As the pace of modern life continues to accelerate, the demand for electronic devices has been steadily increasing. Facing to a huge consumer market, apart from focusing on enhancing the functionality and performance of their products, various manufacturers also strive hard to optimize the connection structure of electronic devices to enhance the market competitiveness of their products.

Taking power connectors as an example, the way to effectively improve their connection compatibility and convenience at low cost is undoubtedly an important issue that the industry highly concerns about.

### SUMMARY

A technical aspect of the present disclosure is to provide a connector, which can adjust its lateral position and/or tilting angle in order to align with another connector, thereby improving the connection compatibility and convenience between it and the other connector.

According to an embodiment of the present disclosure, a connector includes a connecting member, a connecting base and a disc-shaped spring terminal. The connecting member includes a limiting portion and a plug portion connected with the limiting portion. The plug portion extends along a mating direction. The connecting base has an accommodation space and an opening communicated with the accommodation space. The limiting portion is located in the accommodation space. The plug portion passes through the opening. The disc-shaped spring terminal is located in the accommodation space and sandwiched between the connecting base and the limiting portion along the mating direction.

According to an embodiment of the present disclosure, a connector includes a disc-shaped spring terminal, an upper cover and a connecting member. The disc-shaped spring terminal is configured to connect with a printed circuit board. The upper cover includes a cover portion and a plurality of wall portions. The cover portion has an opening. The wall portions are respectively connected with and at least partially inclined relative to the cover portion. The wall portions are configured to connect with the disc-shaped spring terminal. The disc-shaped spring terminal and the cover portion are spaced apart from each other and define an accommodation space therebetween. The accommodation space is communicated with the opening. The connecting member includes a socket portion, a fixing portion and a limiting portion. The fixing portion is connected between the socket portion and the limiting portion along a mating direction. The fixing portion is located in the opening. The limiting portion is located in the accommodation space. The disc-shaped spring terminal at least partially abuts against the limiting portion.

According to an embodiment of the present disclosure, a connector includes a substrate, a disc-shaped spring terminal and a connecting member. The substrate is configured to connect with a printed circuit board. The disc-shaped spring terminal includes an elastic disc and a plurality of conductive walls. The elastic disc has an opening. The elastic disc and the substrate are spaced apart from each other and define an accommodation space therebetween. The accommodation space is communicated with the opening. The conductive walls are connected with an outer edge of the elastic disc and configured to connect with the substrate. The connecting member includes a socket portion, a fixing portion and a limiting portion. The fixing portion is connected between the socket portion and the limiting portion along a mating direction. The fixing portion is located in the opening. The limiting portion is located in the accommodation space. The elastic disc at least partially abuts against the limiting portion.

### BRIEF DESCRIPTION OF THE DRAWINGS

The disclosure can be more fully understood by reading the following detailed description of the embodiments, with reference made to the accompanying drawings as follows:

FIG. 1 is a schematic view of a connector according to an embodiment of the present disclosure;

FIG. 2 is an exploded view of the connector of FIG. 1;

FIG. 3 is a cross-sectional view along the sectional line A-A of FIG. 1;

FIG. 4 is a schematic cross-sectional view illustrating an application of the connector of FIG. 1;

FIG. 5 is a schematic cross-sectional view illustrating another application of the connector of FIG. 1;

FIGS. 6-8 are schematic views of disc-shaped spring terminals according to other embodiments of the present disclosure;

FIG. 9 is a cross-sectional view of a connector according to another embodiment of the present disclosure;

FIG. 10 is a schematic view of a connector according to a further embodiment of the present disclosure;

FIG. 11 is an exploded view of the connector of FIG. 10;

FIG. 12 is a cross-sectional view along the sectional line B-B of FIG. 10;

FIG. 13 is a schematic cross-sectional view illustrating an application of the connector of FIG. 11;

FIG. 14 is a schematic view of a disc-shaped spring terminal according to another embodiment of the present disclosure;

FIG. 15 is a schematic view of a connector according to another embodiment of the present disclosure;

FIG. 16 is an exploded view of the connector of FIG. 15;

FIG. 17 is a cross-sectional view along the sectional line C-C of FIG. 15;

FIG. 18 is a schematic cross-sectional view illustrating an application of the connector of FIG. 15; and

FIG. 19 is a schematic view of a disc-shaped spring terminal according to another embodiment of the present disclosure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

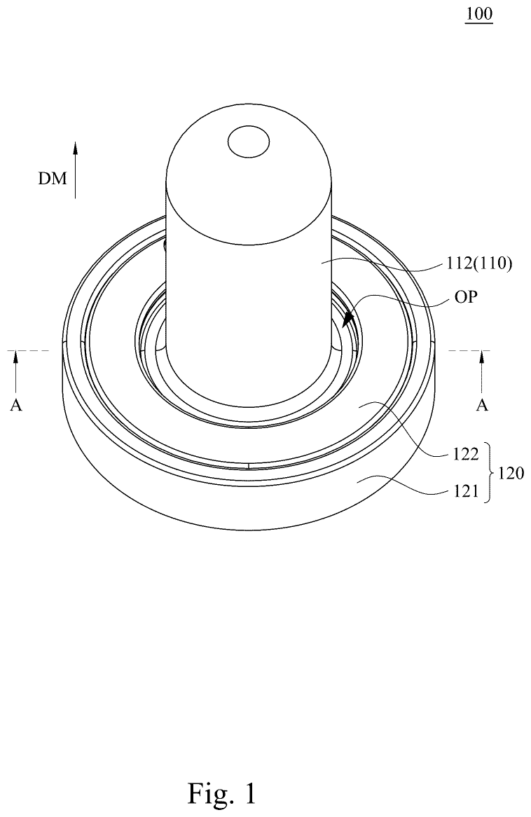

Please refer to FIGS. 1 to 3. The connector 100 is practically a plug connector, which includes a connecting member 110, a connecting base 120, and a disc-shaped spring terminal 130. The connecting member 110 includes a limiting portion 111 and a plug portion 112 connected with the limiting portion 111. The plug portion 112 extends along a mating direction DM. The connecting base 120 has an accommodation space SP and an opening OP communicated with the accommodation space SP. The limiting portion 111 of the connecting member 110 is located in the accommodation space SP, and the plug portion 112 passes through the opening OP. The disc-shaped spring terminal 130 is located in the accommodation space SP of the connecting base 120 and sandwiched between the connecting base 120 and the limiting portion 111 along the mating direction DM. In practice, the connecting member 110, the connecting base 120 and the disc-shaped spring terminal 130 are electrically connected to each other, and the connecting base 120 is adapted to be connected with a printed circuit board 500.

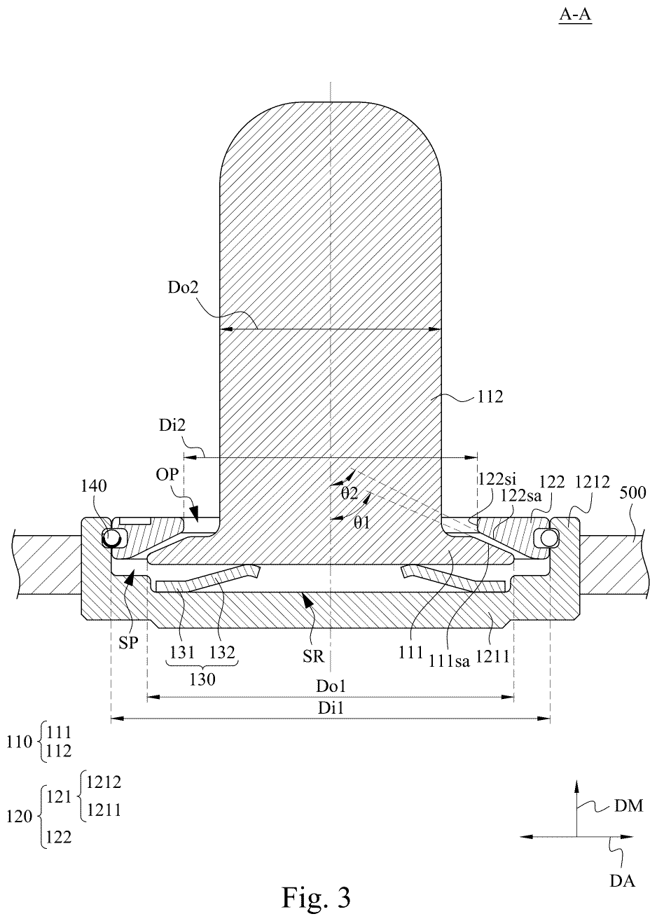

To be more specific, the disc-shaped spring terminal 130 includes an outer ring 131 and a plurality of elastic arms 132. The outer ring 131 is configured to abut against the connecting base 120, and the outer ring 131 surrounds and connects with the elastic arms 132. The elastic arms 132 are spaced apart from each other and at least partially raised relative to the outer ring 131, so that the elastic arms 132 have some elasticity relative to the outer ring 131. As shown in FIG. 3, the elastic arms 132 of the disc-shaped spring terminal 130 are configured to abut against the limiting portion 111 of the connecting member 110.

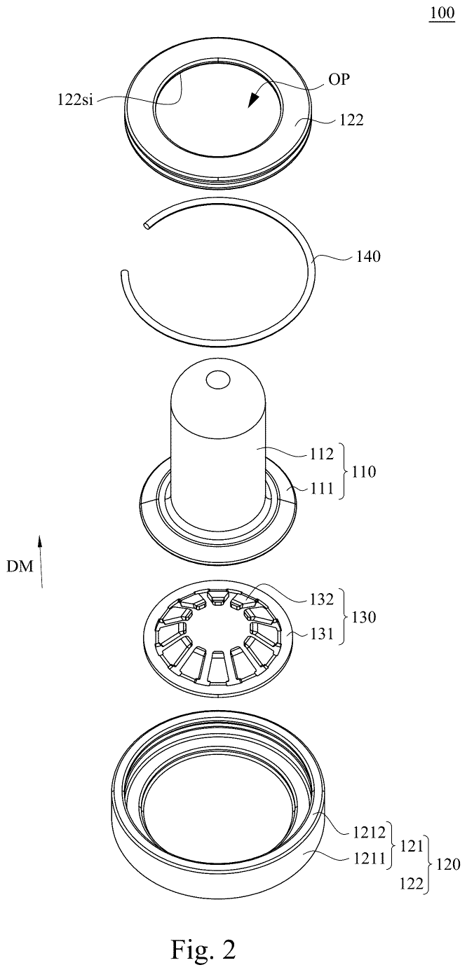

Furthermore, the connecting base 120 includes a bottom shell 121 and a cover body 122. The bottom shell 121 has a bottom wall 1211 and a side wall 1212 connected to the bottom wall 1211. The side wall 1212 surrounds according to a first inner diameter Di1 to define the accommodation space SP. The limiting portion 111 of the connecting member 110 has a first outer diameter Do1. The first inner diameter Di1 is greater than the first outer diameter Do1. The outer ring 131 of the disc-shaped spring terminal 130 is configured to abut against the bottom wall 1211 of the connecting base 120. The cover body 122 is connected with the bottom shell 121 and has an inner wall surface 122si. The inner wall surface 122si surrounds according to a second inner diameter Di2 to define the opening OP. The plug portion 112 has a second outer diameter Do2. In this embodiment, the second inner diameter Di2 of the cover body 122 is greater than the second outer diameter Do2 of the plug portion 112 and smaller than the first outer diameter Do1 of the limiting portion 111. In practical applications, as shown in FIGS. 2-3, the connecting base 120 further includes a C-shaped retaining ring 140. The C-shaped retaining ring 140 is used to snap between the cover body 122 and the side wall 1212 of the bottom shell 121 to fix the relative position of the cover body 122 and the bottom shell 121.

Further, as shown in FIG. 3, the bottom wall 1211 of the bottom shell 121 has a recessed space SR. The recessed space SR is communicated with the accommodation space SP, and the outer ring 131 of the disc-shaped spring terminal 130 is at least partially restricted in the recessed space SR. Thus, the outer ring 131 can be fixed to the bottom wall 1211 without moving relative to the connecting base 120.

Furthermore, the limiting portion 111 of the connecting member 110 has a first inclined surface 111sa. The first inclined surface 111sa at least partially faces to the cover body 122, and is inclined at a first angle θ1 relative to the mating direction DM. Correspondingly, the cover body 122 has a second inclined surface 122sa. The second inclined surface 122sa at least partially faces to the first inclined surface 111sa, and is inclined at a second angle θ2 relative to the mating direction DM. In this embodiment, the first angle θ1 of the limiting portion 111 is greater than the second angle θ2 of the cover body 122.

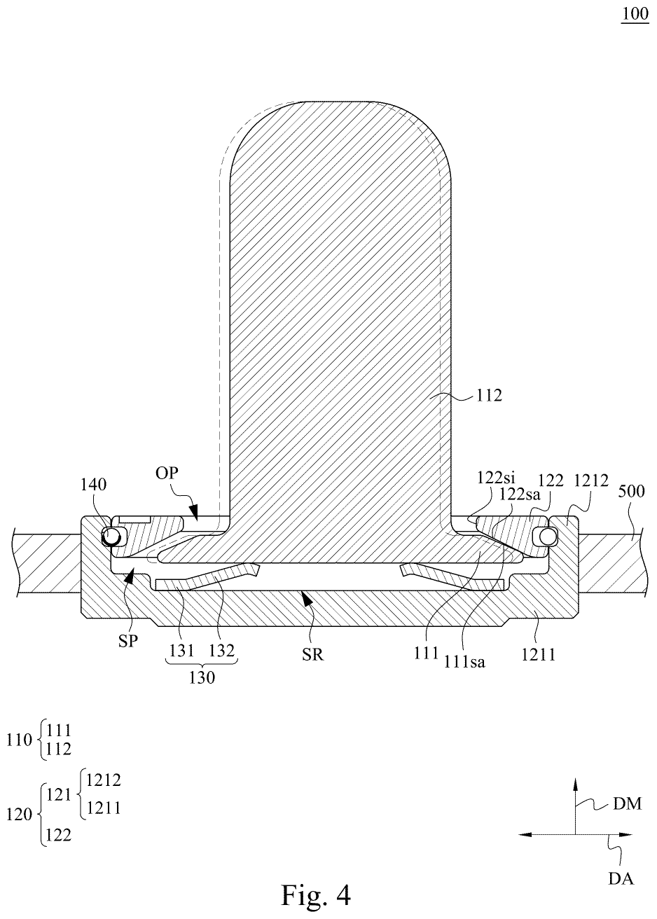

Please refer to FIG. 4. FIG. 4 is a schematic cross-sectional view illustrating an application of the connector 100 of FIG. 1. As mentioned above, since the second inner diameter Di2 of the cover body 122 is greater than the second outer diameter Do2 of the plug portion 112 and smaller than the first outer diameter Do1 of the limiting portion 111, and the first inner diameter Di1 of the side wall 1212 is greater than the first outer diameter Do1 of the limiting portion 111, plus the elastic arms 132 of the disc-shaped spring terminal 130 have some elasticity relative to the outer ring 131, as shown in FIG. 4, while maintaining the mutual connection between the connecting member 110, the connecting base 120 and the disc-shaped spring terminal 130, the connecting member 110 can move relative to the disc-shaped spring terminal 130 and the connecting base 120 along an adjustment direction DA perpendicular to the mating direction DM. In this way, when the connecting member 110 of the connector 100 is connected to another connector (not shown), such as a socket connector, the connecting member 110 can move relative to the disc-shaped spring terminal 130 and the connecting base 120 along the adjustment direction DA, for example, from the position of dashed line to the position of solid line in FIG. 4, to align with the other connector, thereby improving the connection compatibility and convenience between the connector 100 and the other connector.

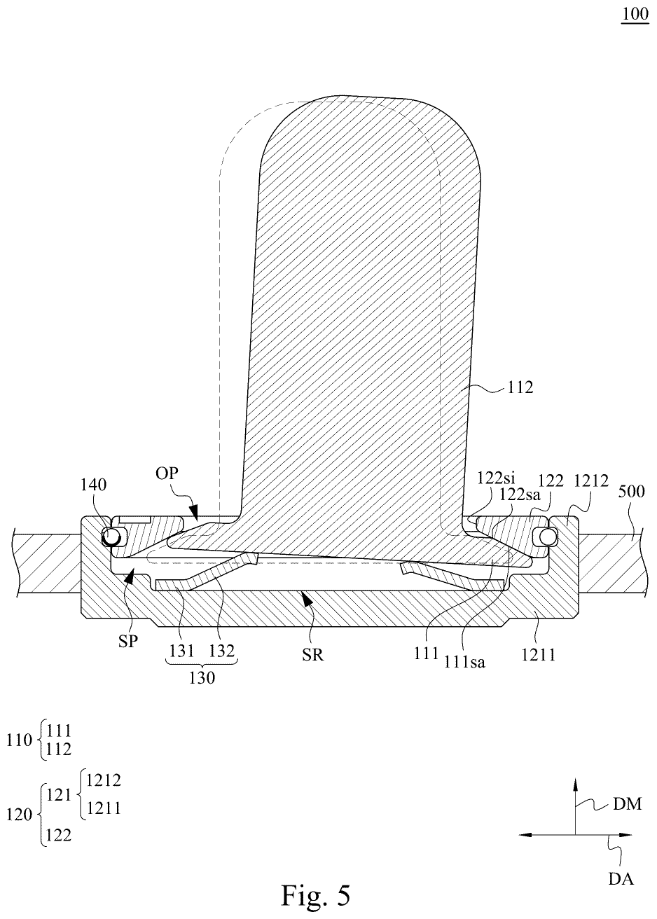

Please refer to FIG. 5. FIG. 5 is a schematic cross-sectional view illustrating another application of the connector 100 of FIG. 1. As mentioned above, the limiting portion 111 of the connecting member 110 has a first inclined surface 111sa. The cover body 122 has a second inclined surface 122sa, and the first angle θ1 of the first inclined surface 111sa is greater than the second angle θ2 of the second inclined surface 122sa. In this way, since the elastic arms 132 of the disc-shaped spring terminal 130 have some elasticity relative to the outer ring 131, and while maintaining the mutual connection between the connecting member 110, the connecting base 120 and the disc-shaped spring terminal 130, the connecting member 110 can tilt relative to the disc-shaped spring terminal 130 and the connecting base 120. When the connecting member 110 tilts relative to the disc-shaped spring terminal 130 and the connecting base 120 until the first inclined surface 111sa of the limiting portion 111 abuts against the second inclined surface 122sa of the cover body 122, for example, tilting from the position of dashed line to the position of solid line in FIG. 5, the connecting member 110 can reach the maximum tilting angle, and this maximum tilting angle is practically equal to the difference between the second angle θ2 and the first angle θ1. For example, when the first angle θ1 is 50 degrees while the second angle θ2 is 45 degrees, the connecting member 110 can tilt 5 degrees relative to the disc-shaped spring terminal 130 and the connecting base 120. In this way, when the connecting member 110 of the connector 100 is connected to another connector, such as a socket connector, apart from moving relative to the disc-shaped spring terminal 130 and the connecting base 120 along the adjustment direction DA, the connecting member 110 can also tilt relative to the disc-shaped spring terminal 130 and the connecting base 120 to align with the other connector, thereby improving the connection compatibility and convenience between the connector 100 and the other connector.

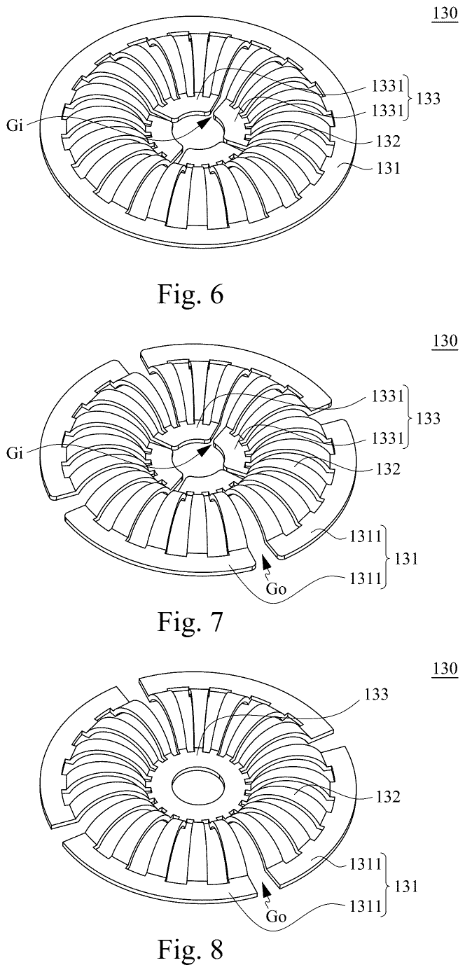

Please refer to FIGS. 6-8, which are schematic views of disc-shaped spring terminals 130 according to other embodiments of the present disclosure. According to the actual situations, the disc-shaped spring terminal 130 includes an inner ring 133. The elastic arms 132 are connected between the inner ring 133 and the outer ring 131, and at least partially protrude relative to the inner ring 133 and the outer ring 131 to form a curved shape. As shown in FIG. 6, the inner ring 133 is composed of a plurality of arc-shaped segments 1331. The arc-shaped segments 1331 are spaced apart from each other, that is, there is a gap Gi between adjacent two of the arc-shaped segments 1331. The elastic arms 132 are respectively connected to a corresponding one of the arc-shaped segments 1331, while the outer ring 131 is in a complete annular shape. As shown in FIG. 7, in addition to the inner ring 133 being composed of a plurality of arc-shaped segments 1331 which are spaced apart from each other, the outer ring 131 is also composed of a plurality of arc-shaped segments 1311, and the arc-shaped segments 1311 are also spaced apart from each other, that is, there is a gap Go between adjacent two of the arc-shaped segments 1311. The elastic arms 132 are respectively connected between a corresponding one of the arc-shaped segments 1331 and a corresponding one of the arc-shaped segments 1311. As shown in FIG. 8, the inner ring 133 is in a complete annular shape. The outer ring 131 is composed of a plurality of arc-shaped segments 1311, and the arc-shaped segments 1311 are spaced apart from each other, that is, there is a gap Go between adjacent arc-shaped segments 1311. The elastic arms 132 are respectively connected to a corresponding one of the arc-shaped segments 1311.

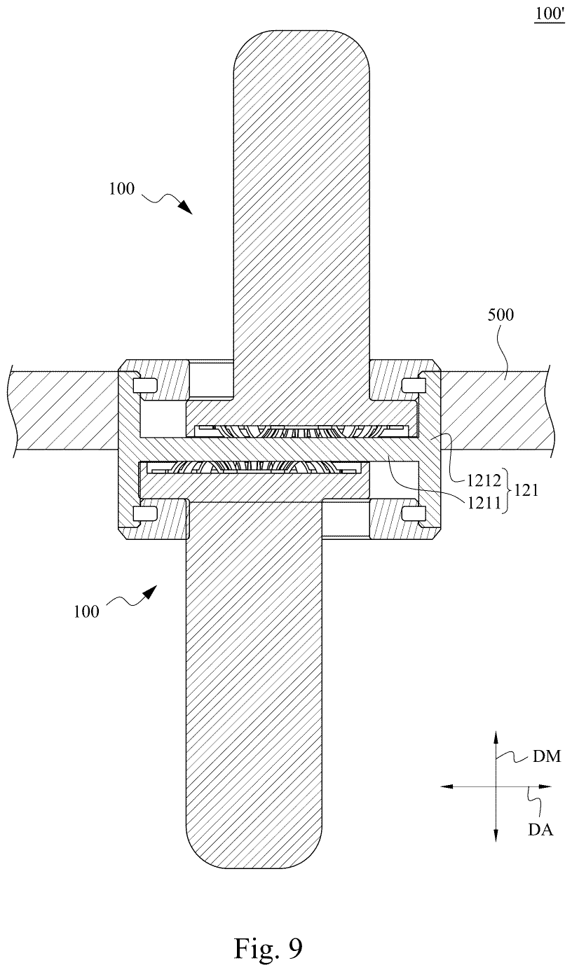

Please refer to FIG. 9, which is a cross-sectional view of a connector 100′ according to another embodiment of the present disclosure. In this embodiment, the connector 100′ is formed by connecting two of the aforementioned connectors 100 back-to-back. To be specific, according to the actual situations, the two connectors 100 have a common bottom wall 1211, that is, the bottom shells 121 of the two connectors 100 are of a common structure. In practical applications, the connecting members 110 of the two connectors 100 can respectively move and tilt relative to the bottom shell 121 along the adjustment direction DA.

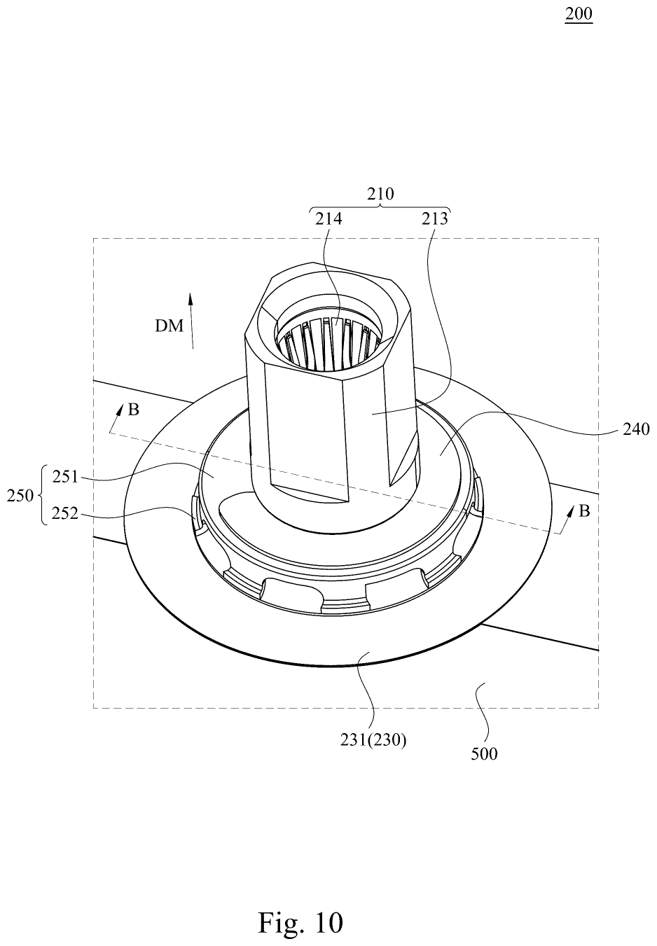

Please refer to FIGS. 10 to 12. In this embodiment, the connector 200 is practically a socket connector, which includes a disc-shaped spring terminal 230, an upper cover 250 and a connecting member 210. The disc-shaped spring terminal 230 is configured to connect with a printed circuit board 500. The upper cover 250 includes a cover portion 251 and a plurality of wall portions 252. The cover portion 251 has an opening OP. The wall portions 252 are respectively connected with and at least partially inclined relative to the cover portion 251, and are configured to connect with the disc-shaped spring terminal 230. Furthermore, the wall portions 252 are spaced apart from each other to improve the heat dissipation effect of the connector 200. The disc-shaped spring terminal 230 and the cover portion 251 are spaced apart from each other and define an accommodation space SP therebetween. The accommodation space SP is communicated with the opening OP. The connecting member 210 includes a socket portion 213, a fixing portion 212 and a limiting portion 211. The fixing portion 212 is connected between the socket portion 213 and the limiting portion 211 along a mating direction DM. The fixing portion 212 is located in the opening OP. The limiting portion 211 is located in the accommodation space SP. The disc-shaped spring terminal 230 at least partially abuts against a side of the limiting portion 211 away from the socket portion 213. In practice, the connecting member 210 and the disc-shaped spring terminal 230 are electrically connected to each other, and a crown terminal 214 may be disposed in the socket portion 213 of the connecting member 210 to connect with another connector (not shown), such as a plug connector.

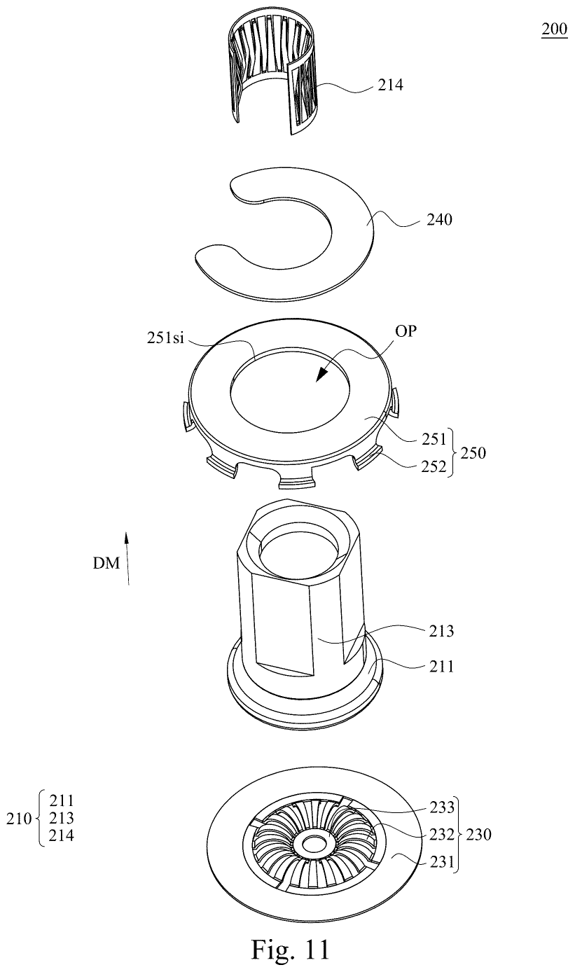

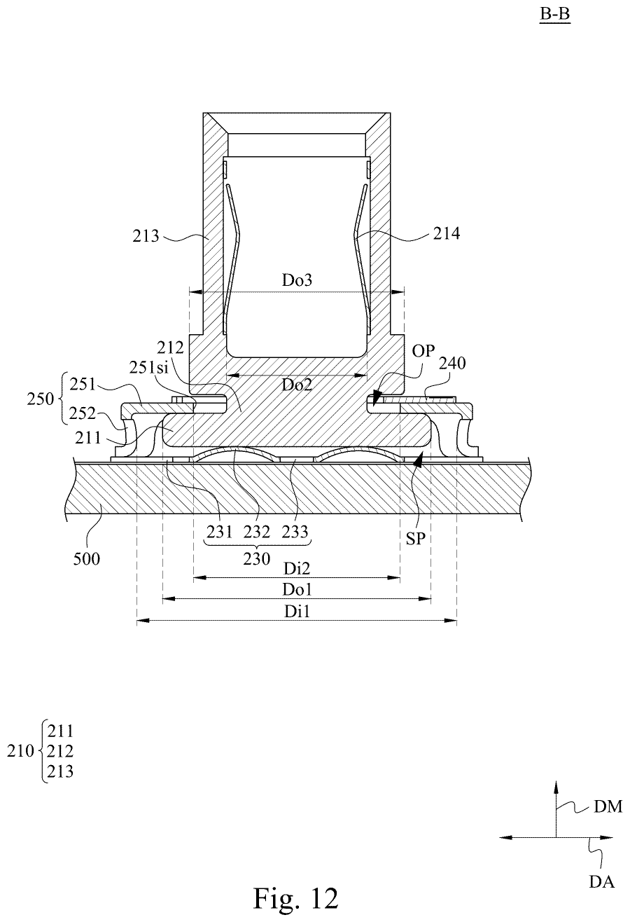

To be more specific, as shown in FIGS. 11-12, the disc-shaped spring terminal 230 includes an outer ring 231, an inner ring 233 and a plurality of elastic arms 232. The outer ring 231 is configured to connect with the printed circuit board 500, for example, by soldering. The elastic arms 232 are connected between the inner ring 233 and the outer ring 231, and respectively at least partially protrude relative to the inner ring 233 and the outer ring 231 to form a curved shape, so that the elastic arms 232 have some elasticity relative to the outer ring 231 and the inner ring 233. As shown in FIG. 12, the elastic arms 232 are configured to abut against a side of the limiting portion 211 away from the socket portion 213.

Furthermore, as shown in FIG. 12, the wall portions 252 of the upper cover 250 surround according to a first inner diameter Di1 to define the accommodation space SP. The limiting portion 211 of the connecting member 210 has a first outer diameter Do1. The first inner diameter Di1 is greater than the first outer diameter Do1. The cover portion 251 has an inner wall surface 251si. The inner wall surface 251si surrounds according to a second inner diameter Di2 to define the opening OP. The fixing portion 212 has a second outer diameter Do2. The second inner diameter Di2 of the cover portion 251 is greater than the second outer diameter Do2 of the fixing portion 212 and smaller than the first outer diameter Do1 of the limiting portion 211. In this way, the connecting member 210 is fixed relative to the upper cover 250 along the mating direction DM. Furthermore, the socket portion 213 has a third outer diameter Do3. The third outer diameter Do3 is greater than the second inner diameter Di2 of the cover portion 251. In practical applications, as shown in FIGS. 10-12, the connector 200 further includes a C-shaped retaining ring 240. The C-shaped retaining ring 240 is at least partially sandwiched between the socket portion 213 of the connecting member 210 and the cover portion 251 of the upper cover 250 to fix the relative position of the connecting member 210 and the upper cover 250.

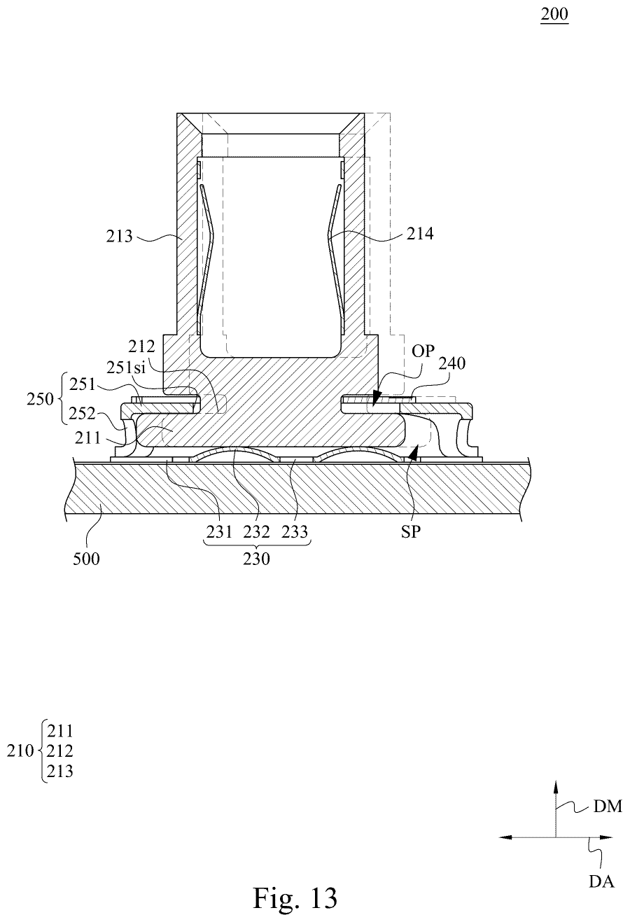

Please refer to FIG. 13. As mentioned above, since the second inner diameter Di2 of the cover portion 251 is greater than the second outer diameter Do2 of the fixing portion 212 and smaller than the first outer diameter Do1 of the limiting portion 211, and the first inner diameter Di1 of the wall portions 252 is greater than the first outer diameter Do1 of the limiting portion 211, plus the elastic arms 232 of the disc-shaped spring terminal 230 have some elasticity relative to the outer ring 231 and the inner ring 233, as shown in FIG. 13, while maintaining the mutual connection between the disc-shaped spring terminal 230 and the connecting member 210, the connecting member 210 can move relative to the disc-shaped spring terminal 230 and the upper cover 250 along an adjustment direction DA perpendicular to the mating direction DM. In this way, when the connecting member 210 of the connector 200 is connected to another connector, such as a plug connector, the connecting member 210 can move relative to the disc-shaped spring terminal 230 and the upper cover 250 along the adjustment direction DA, for example, from the position of dashed line to the position of solid line in FIG. 13, to align with the other connector, thereby improving the connection compatibility and convenience between the connector 200 and the other connector.

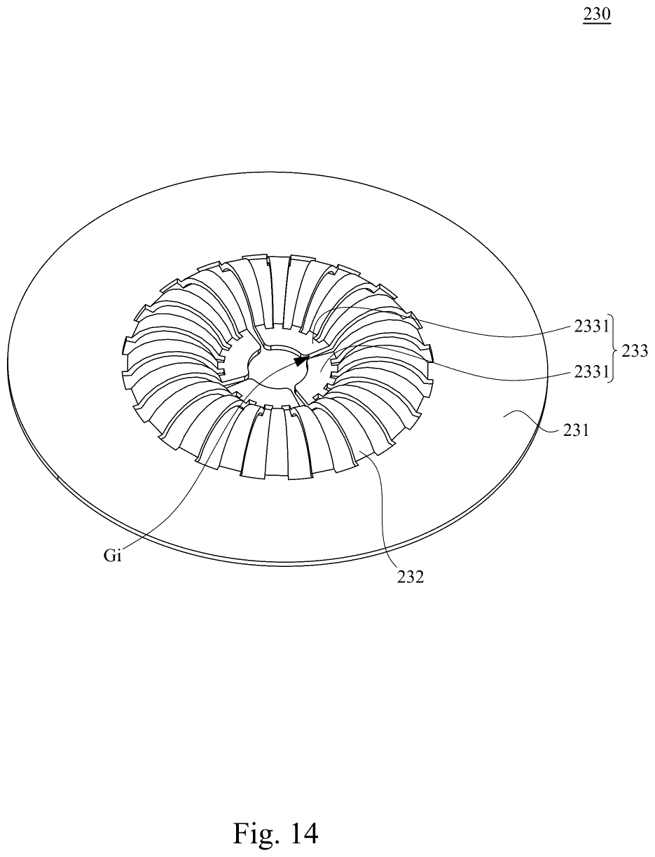

Please refer to FIG. 14, which is a schematic view of a disc-shaped spring terminal 230 according to another embodiment of the present disclosure. In this embodiment, the inner ring 233 of the disc-shaped spring terminal 230 is composed of a plurality of arc-shaped segments 2331. The arc-shaped segments 2331 are spaced apart from each other, that is, there is a gap Gi between adjacent two of the arc-shaped segments 2331. The elastic arms 232 are respectively connected to a corresponding one of the arc-shaped segments 2331, while the outer ring 231 is in a complete annular shape.

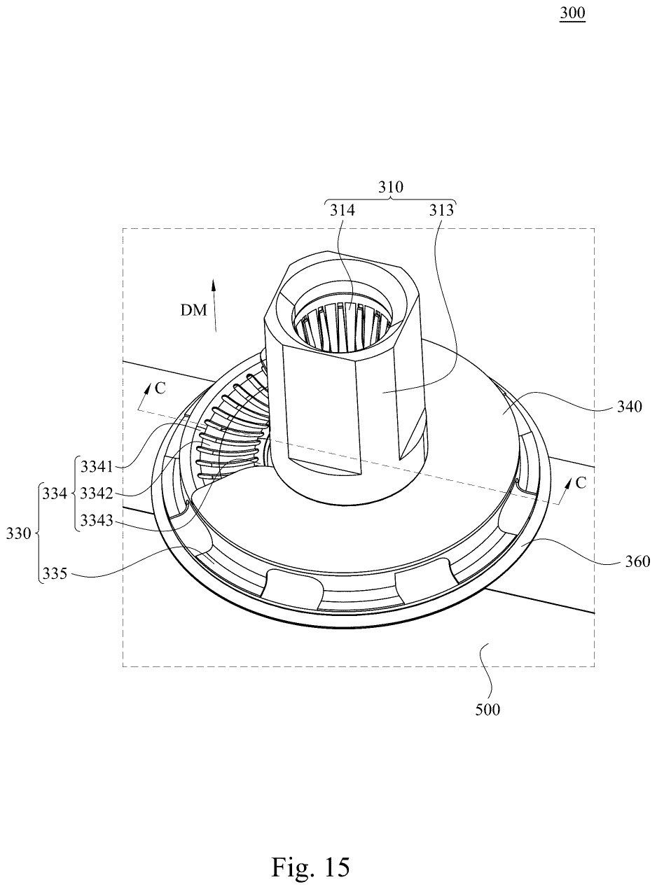

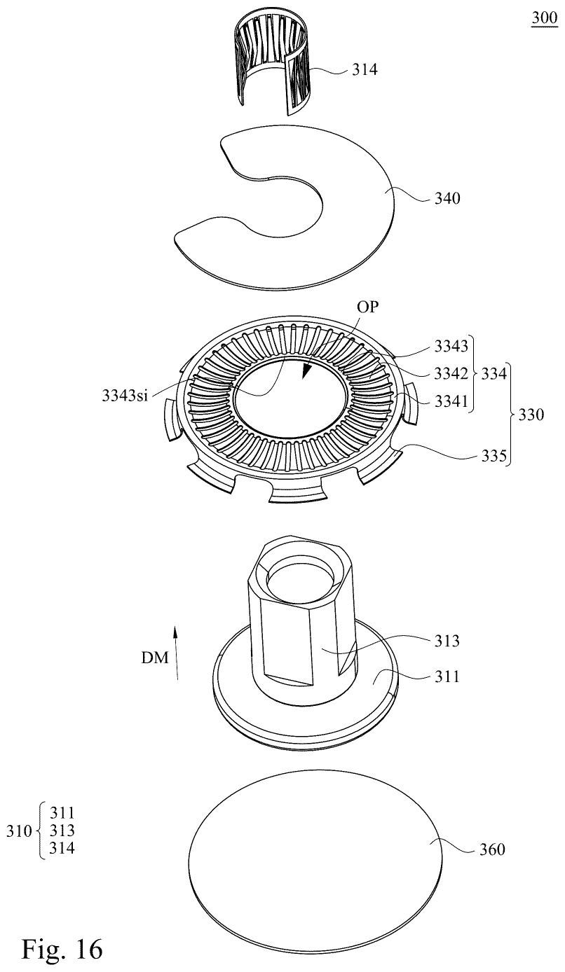

Please refer to FIGS. 15-17. The connector 300 is practically a socket connector, which includes a substrate 360, a disc-shaped spring terminal 330 and a connecting member 310. The substrate 360 is configured to connect with a printed circuit board 500. The substrate 360 is, for example, a surface-mount substrate. The disc-shaped spring terminal 330 includes an elastic disc 334 and a plurality of conductive walls 335. The elastic disc 334 has an opening OP. The elastic disc 334 and the substrate 360 are spaced apart from each other and define an accommodation space SP therebetween. The accommodation space SP is communicated with the opening OP. The conductive walls 335 are connected with an outer edge of the elastic disc 334 and configured to connect with the substrate 360. Furthermore, the conductive walls 335 are spaced apart from each other to improve the heat dissipation effect of the connector 300. The connecting member 310 includes a socket portion 313, a fixing portion 312 and a limiting portion 311. The fixing portion 312 is connected between the socket portion 313 and the limiting portion 311 along a mating direction DM. The fixing portion 312 is located in the opening OP. The limiting portion 311 is located in the accommodation space SP. The elastic disc 334 at least partially abuts against a side of the limiting portion 311 facing to the socket portion 313. In practice, the substrate 360, the disc-shaped spring terminal 330 and the connecting member 310 are electrically connected to each other, and a crown terminal 314 may be disposed in the socket portion 313 of the connecting member 310 to connect with another connector (not shown), such as a plug connector.

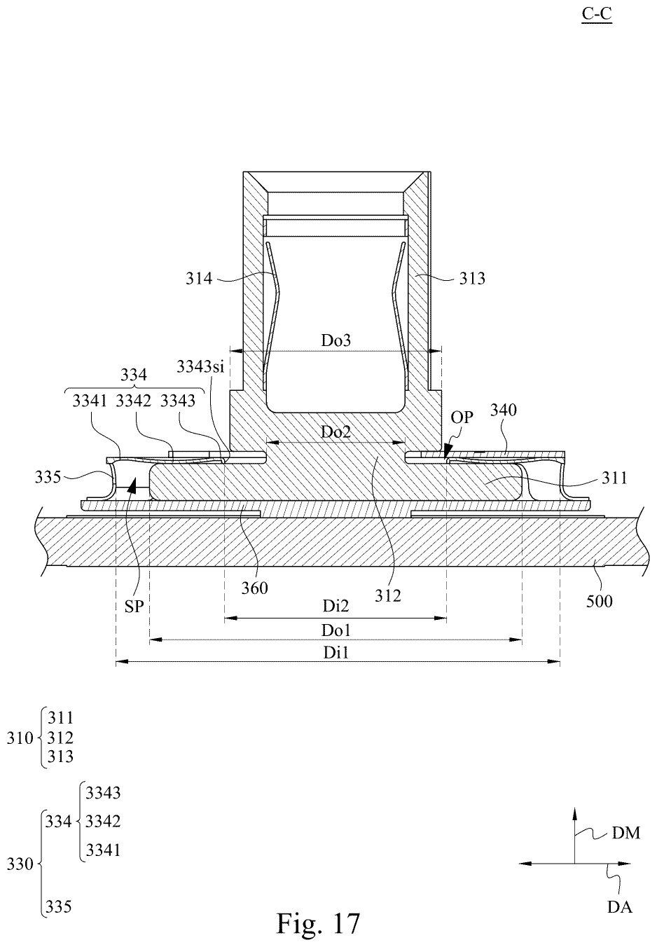

To be more specific, the elastic disc 334 includes an outer ring 3341, an inner ring 3343 and a plurality of elastic arms 3342. The conductive walls 335 are connected to an outer edge of the outer ring 3341. The inner ring 3343 has the opening OP. The elastic arms 3342 are connected between the inner ring 3343 and the outer ring 3341, and respectively at least partially protrude relative to the inner ring 3343 and the outer ring 3341 to form a curved shape, so that the elastic arms 3342 have some elasticity relative to the outer ring 3341 and the inner ring 3343. As shown in FIG. 17, the elastic arms 3342 are configured to abut against a side of the limiting portion 311 facing to the socket portion 313, that is, the elastic arms 3342 are configured to press the limiting portion 311 towards the substrate 360.

Furthermore, as shown in FIG. 17, the conductive walls 335 of the disc-shaped spring terminal 330 surround according to a first inner diameter Di1 to define the accommodation space SP. The limiting portion 311 of the connecting member 310 has a first outer diameter Do1. The first inner diameter Di1 is greater than the first outer diameter Do1. The inner ring 3343 has an inner wall surface 3343si. The inner wall surface 3343si surrounds according to a second inner diameter Di2 to define the opening OP. The fixing portion 312 has a second outer diameter Do2. The second inner diameter Di2 of the elastic disc 334 is greater than the second outer diameter Do2 of the fixing portion 312 and smaller than the first outer diameter Do1 of the limiting portion 311. In this way, the connecting member 310 is fixed relative to the disc-shaped spring terminal 330 along the mating direction DM. Furthermore, the socket portion 313 has a third outer diameter Do3. The third outer diameter Do3 is greater than the second inner diameter Di2 of the elastic disc 334. In practical applications, the connector 300 further includes a C-shaped retaining ring 340. The C-shaped retaining ring 340 is at least partially sandwiched between the socket portion 313 of the connecting member 310 and the elastic disc 334 of the disc-shaped spring terminal 330 to fix the relative position of the connecting member 310 and the disc-shaped spring terminal 330.

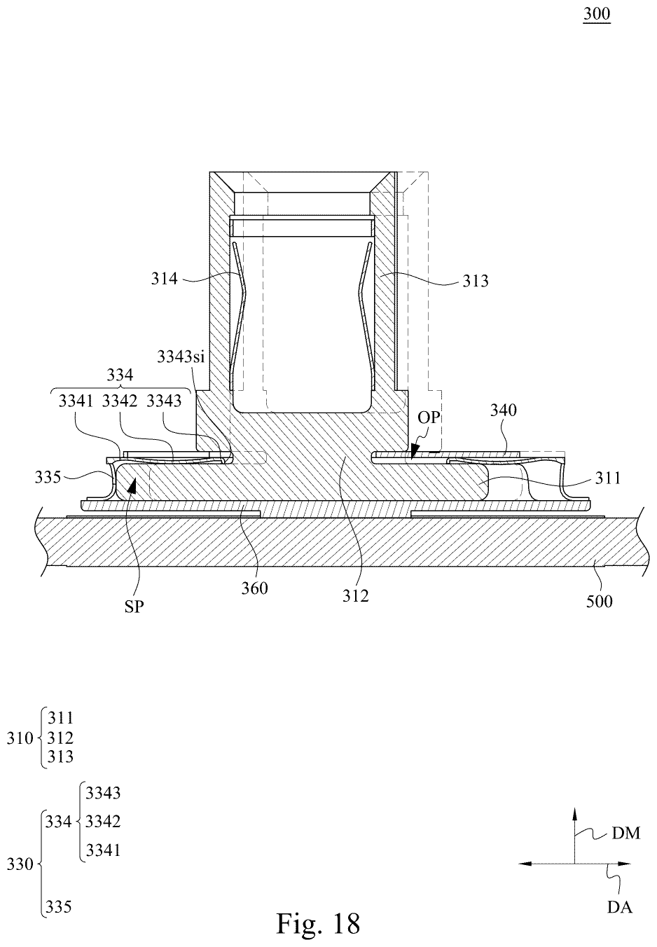

Please refer to FIG. 18. As mentioned above, since the second inner diameter Di2 of the elastic disc 334 is greater than the second outer diameter Do2 of the fixing portion 312 and smaller than the first outer diameter Do1 of the limiting portion 311, and the first inner diameter Di1 of the conductive walls 335 is greater than the first outer diameter Do1 of the limiting portion 311, plus the elastic arms 3342 of the elastic disc 334 have some elasticity relative to the outer ring 3341 and the inner ring 3343, as shown in FIG. 18, while maintaining the mutual connection between the elastic disc 334 and the connecting member 310, the connecting member 310 can move relative to the disc-shaped spring terminal 330 and the substrate 360 along an adjustment direction DA perpendicular to the mating direction DM. In this way, when the connecting member 310 of the connector 300 is connected to another connector, such as a plug connector, the connecting member 310 can move relative to the disc-shaped spring terminal 330 and the substrate 360 along the adjustment direction DA, for example, from the position of dashed line to the position of solid line in FIG. 18, to align with the other connector, thereby improving the connection compatibility and convenience between the connector 300 and the other connector.

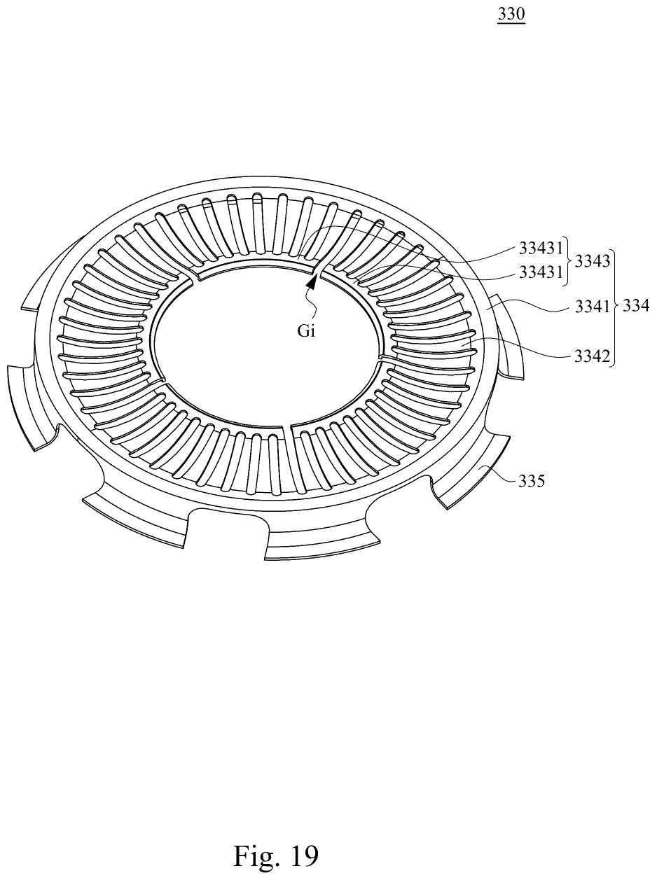

Please refer to FIG. 19. The inner ring 3343 of the elastic disc 334 is composed of a plurality of arc-shaped segments 33431. The arc-shaped segments 33431 are spaced apart from each other, that is, there is a gap Gi between adjacent arc-shaped segments 33431. The elastic arms 3342 are respectively connected to a corresponding one of the arc-shaped segments 33431, while the outer ring 3341 is in a complete annular shape.

In conclusion, the aforementioned embodiments of the present disclosure have at least the following advantages:
(1) When the connecting member of the connector is connected to another connector, such as a socket connector or a plug connector, the connecting member can move relative to the disc-shaped spring terminal and the connecting base along the adjustment direction, in order to align with the other connector, thereby improving the connection compatibility and convenience between the connector and the other connector.
(2) When the connecting member of the connector is connected to another connector, such as a socket connector, apart from moving relative to the disc-shaped spring terminal and the connecting base along the adjustment direction, the connecting member can also tilt relative to the disc-shaped spring terminal and the connecting base in order to align with the other connector, thereby improving the connection compatibility and convenience between the connector and the other connector.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A connector, comprising:
a connecting member comprising a limiting portion and a plug portion connected with the limiting portion, the plug portion extending along a mating direction;
a connecting base having an accommodation space and an opening communicated with the accommodation space, the limiting portion being located in the accommodation space, the plug portion passing through the opening; and
a disc-shaped spring terminal located in the accommodation space and sandwiched between the connecting base and the limiting portion along the mating direction.

2. The connector of claim 1, wherein the disc-shaped spring terminal comprises:
an outer ring configured to abut against the connecting base; and
a plurality of elastic arms, the outer ring surrounds and connects with the elastic arms, the elastic arms are spaced apart from each other and respectively at least partially raised relative to the outer ring, the elastic arms are configured to abut against the limiting portion.

3. The connector of claim 2, wherein the connecting base comprises:
a bottom shell having a bottom wall and a side wall connected to the bottom wall, the side wall surrounds according to a first inner diameter to define the accommodation space, the limiting portion has a first outer diameter, the first inner diameter is greater than the first outer diameter, the outer ring is configured to abut against the bottom wall; and
a cover body connected to the bottom shell and having an inner wall surface, the inner wall surface surrounds according to a second inner diameter to define the opening, the plug portion has a second outer diameter, the second inner diameter is greater than the second outer diameter and smaller than the first outer diameter.

4. The connector of claim 3, wherein the bottom wall has a recessed space communicated with the accommodation space, the outer ring is at least partially restricted in the recessed space.

5. The connector of claim 3, wherein the limiting portion has a first inclined surface at least partially facing to the cover body, the cover body has a second inclined surface at least partially facing to the first inclined surface, the first inclined surface is inclined at a first angle relative to the mating direction, the second inclined surface is inclined at a second angle relative to the mating direction, the first angle is greater than the second angle, a difference between the first angle and the second angle defines a maximum allowable tilting angle of the connecting member relative to the disc-shaped spring terminal and the connecting base when the first inclined surface abuts against the second inclined surface.

6. The connector of claim 2, wherein the disc-shaped spring terminal comprises:
an inner ring, the elastic arms are connected between the inner ring and the outer ring, and respectively at least partially protrude relative to the inner ring and the outer ring to form a curved shape.

7. The connector of claim 6, wherein the inner ring comprises a plurality of arc-shaped segments spaced apart from each other, the elastic arms are respectively connected to a corresponding one of the arc-shaped segments.

8. The connector of claim 6, wherein the outer ring comprises a plurality of arc-shaped segments spaced apart from each other, the elastic arms are respectively connected to a corresponding one of the arc-shaped segments.

9. A connector, comprising:
a disc-shaped spring terminal configured to connect with a printed circuit board;
an upper cover comprising a cover portion and a plurality of wall portions, the cover portion having an opening, the wall portions being respectively connected with and at least partially inclined relative to the cover portion, and configured to connect with the disc-shaped spring terminal, the disc-shaped spring terminal and the cover portion being spaced apart from each other and defining an accommodation space therebetween, the accommodation space being communicated with the opening; and
a connecting member comprising a socket portion, a fixing portion and a limiting portion, the fixing portion being connected between the socket portion and the limiting portion along a mating direction, the fixing portion being located in the opening, the limiting portion being located in the accommodation space, the disc-shaped spring terminal at least partially abutting against the limiting portion.

10. The connector of claim 9, wherein the disc-shaped spring terminal comprises:
an outer ring configured to connect with the printed circuit board;
an inner ring; and
a plurality of elastic arms connected between the inner ring and the outer ring, and respectively at least partially protruding relative to the inner ring and the outer ring to form a curved shape, the elastic arms are configured to abut against the limiting portion.

11. The connector of claim 10, wherein the inner ring comprises a plurality of arc-shaped segments spaced apart from each other, the elastic arms are respectively connected with a corresponding one of the arc-shaped segments.

12. The connector of claim 9, wherein the wall portions surround according to a first inner diameter, the limiting portion has a first outer diameter, the first inner diameter is greater than the first outer diameter, the cover portion has an inner wall surface, the inner wall surface surrounds according to a second inner diameter to define the opening, the fixing portion has a second outer diameter, the second inner diameter is greater than the second outer diameter and smaller than the first outer diameter.

13. The connector of claim 12, wherein the socket portion has a third outer diameter, the third outer diameter is greater than the second inner diameter.

14. The connector of claim 9, wherein the wall portions are spaced apart from each other.

15. A connector, comprising:
a substrate configured to connect with a printed circuit board;
a disc-shaped spring terminal comprising an elastic disc and a plurality of conductive walls, the elastic disc having an opening, the elastic disc and the substrate being spaced apart from each other and defining an accommodation space therebetween, the accommodation space being communicated with the opening, the conductive walls being connected with an outer edge of the elastic disc and configured to connect with the substrate; and
a connecting member comprising a socket portion, a fixing portion and a limiting portion, the fixing portion being connected between the socket portion and the limiting portion along a mating direction, the fixing portion being located in the opening, the limiting portion being located in the accommodation space, the elastic disc at least partially abutting against the limiting portion.

16. The connector of claim 15, wherein the elastic disc comprises:
an outer ring connected with the conductive walls;
an inner ring having the opening; and
a plurality of elastic arms connected between the inner ring and the outer ring, and respectively at least partially protruding relative to the inner ring and the outer ring to form a curved shape, the elastic arms are configured to abut against the limiting portion.

17. The connector of claim 16, wherein the conductive walls surround according to a first inner diameter to define the accommodation space, the limiting portion has a first outer diameter, the first inner diameter is greater than the first outer diameter, the inner ring has an inner wall surface, the inner wall surface surrounds according to a second inner diameter to define the opening, the fixing portion has a second outer diameter, the second inner diameter is greater than the second outer diameter and smaller than the first outer diameter.

18. The connector of claim 17, wherein the socket portion has a third outer diameter, the third outer diameter is greater than the second inner diameter.

19. The connector of claim 16, wherein the inner ring comprises a plurality of arc-shaped segments spaced apart from each other, the elastic arms are respectively connected to a corresponding one of the arc-shaped segments.

20. The connector of claim 15, wherein the conductive walls are spaced apart from each other.
